(19) United States
(12) Patent Application Publication
(10) Pub. No.: US 2003/0052226 A1
(43) Pub. Date: Mar. 20, 2003

(54) Aircraft integrated non-lethal weapon system ainlws

(76) Inventor: Dillis V. Allen, Elgin, IL (US)

Correspondence Address: DILLIS V. ALLEN, Suite 205, 1080 Nerge Road, Elk Grove Village, IL, 60007, US

(21) Appl. No.: 09/955,898

(22) Filed: Sep. 19, 2001

(51) Int. Cl. B64D 11/00; B64D 13/00

(52) U.S. Cl. 244/118.5

(57) ABSTRACT

An aircraft integrated non-lethal weapon system AINLWS for commercial aircraft with a sealed bulkhead between the cockpit and the cabin. The cockpit has an air-conditioning system CAS separate from the cabin air-conditioning system PAS, the non-lethal weapon NLW material is injected into the cabin by a NLW supply system, and the cabin is exhausted, after securement, by an NLW exhaust system and the cabin returned to the cabin air system.

### BACKGROUND OF THE INVENTION

The tragic events of September 11, 2001, underscores dramatically the need for preventing ingress of hijackers into the cockpits of commercial airplanes. The present bulkheads and flimsy doors have been characterized by television analysts and newscasters as easily kicked in by an 8 year old boy. Another problem evident from this singular day in history is the proficient piloting skills of many of these terrorists-hijackers enabling them to precision fly most commercial aircraft without coercing or threatening the original pilot of the aircraft to pilot the aircraft to the destination desired by the hijacker. Unfortunately, this is due in part to the American penchant for commercial aircraft visualization and training at a rather low cost to any person desirous of purchasing flight simulator software.

These deficiencies have inspired even prior to September 11, 2001, a build-up in the strength and security of the bulkhead separating the passenger cabin from the cockpit in a few commercial aircraft. However, such an increase in bulkhead strength and security alone will not be completely effective because of the threat of bombs or the explosion of bombs in the cabin compartment and the injury or assassination of passengers and flight attendants in the cabin compartment which may prompt an egress of cockpit personnel in an attempt to aid the problems in the cabin. This exposes the cockpit to take-over by the terrorists-hijackers.

It is apparent that non-lethal weapon systems provide the best solution to the aircraft hijacking problem.

There are many conditions under which deadly force is contraindicated by operational objectives. Unfortunately, since many low-intensity operations carry the threat of violence, the soldier, diplomat, or relief worker may still be in danger. The non-lethal weapon is an effective trade off between lethality and effectiveness. The ideal weapon must incapacitate the threat to the extent that it is not a threat anymore. This requires a careful balance between using too much force—which would reassert the weapon as lethal—or too little, thus only endangering the operator. To be an effective alternative to deadly force, the traditional mechanism for the soldier or marshal, the ideal non-lethal weapon must first meet the criteria of composition. Feasibility for use in the field depends on a weapon being portable and lightweight. In addition, the weapon must have the ability to be used over a considerable distance so that the solider or marshal is not endangered by having to make a last-second decision regarding the level of the threat. Although training is required to teach the circumstances for the use of any weapon, the person using a non-lethal weapon must be even more aware of the situation around him because employment of the weapon typically depends on the extent of the threat, as opposed to just the existence of the threat itself.

The next criteria to be examined for any non-lethal weapon is capability. The weapon must be able to stop a person effectively without causing death or permanent damage. Human beings vary in physical structure; therefore, it is possible for the same weapon to be effective on some and not on others. Even more worrisome is the fact that the amount of force might be too much, resulting in death or maiming. The possibility of abuse looms large when it is virtually impossible to measure in advance whether or not a given level of force will be effective. The flip side of this issue is also of great concern. The person armed with an ineffective non-lethal weapon is completely vulnerable in the face of a threat that has lethal force. In fact, the prevalence of lethal force today, incarnate primary as a conventional gun, is of grave concern. The mere fact that a soldier will be carrying a non-lethal weapon in the face of a potentially lethal threat lends itself to the tendency to err towards more power than less.

The limitations stated above directly applies to the final attribute essential for creating a feasible non-lethal weapon. The power must be a variable. The operator must determine when to set a weapon on maximum level if put in the position of an attacking mob, or when to adjust it to a lower level to be used against children grabbing for his sidearm. The best power setting will neutralize the threat immediately, completely, and temporarily, with little or no side effects. “Set phasers to stun” may sound like science fiction, but the ability is essential if a non-lethal weapon is to be effective.

There are various trade-offs with each weapon, and each has a different application and is thus relatively restrictive in application. This is an inherent weakness of any weapon in that having access to all the variations of weapons for the situations that may arise is virtually impossible. The key must be to limit the uncertainty that may arise in a scenario, therefore narrowing the potential threats and ensuring the solder has the proper weapon of choice.

The first classification of non-lethal weapons is weapons that stun. These weapons are already through the developmental stage and are in use in municipal police forces as well as being stocked in military arsenals.

Stun grenades have been around for the past several decades. Often known as “flash bangs”, they operate primarily by creating a blinding flash of light followed by a loud explosion. The concussion renders the threat stunned, at least temporarily. The weakness of this weapon is that if it is used too close to the threat, it will kill them; and if used at too great a distance, it will be ineffective and only make the operator vulnerable to counter-attack. the ideal situation for the use of this weapon is crowd dispersal and riot control. Also, the flash-bang will often be more effective in less-developed countries, as they tend to be more vulnerable to unexpected and unnatural noises.

Plastic bullets have been used by the Israeli military with limited success. The goal of the rubber bullet is to inflict the right amount of pain to cause the threat to decease charging, or to disperse a crowd. At close ranges, the muzzle velocity of the round is fatal; yet, without significant velocity the bullet is widely inaccurate and often drops to the ground. Because of this, there is a very narrow distance in which they are effective as a deterrent. Also, the rubber bullet can cause serious damage if it hits anywhere other than the chest. A shot to the face or the groin area can cause permanent damage or even death.

Another type of alternate projectile is the beanbag bullet. Fired from a shotgun-like air-powered device, the bean-bag bullet is a fabric container filled with either plastic or rubber shot. The effects and limitations are similar to those of the rubber bullet. Another variation of this type of projectile is the 40-mm non-lethal sponge grenade. Developed in direct response to an urgent request from U.S. Southern Command, the projectile has a plastic body equipped with a foam rubber nose. It is part of the ongoing Soldier Enhancement Program initiative begun in FY96. Fired from the M203 grenade launcher, the weapon allows the soldier to maintain a considerable standoff distance and still have knock-down power, but with limited lethality consequences.

The next area of research for weapons that stun is the chemical arena. The use of chemical weapons in military operations other than war is extremely limited because chemical weapons are strictly controlled by several international treaties. However, since the use of some chemical weapons is allowed to resolve internal problems, an overview of the options available is relevant because U.S. forces often work in conjunction with a foreign nation's military for various MOOTW.

CS gas, commonly referred to as tear gas, is used by police and riot control forces. The gas affects a person's external and internal membranes, proving to be a considerable irritant to the eyes, throat, and lungs. While usually not fatal, nausea and faintness are potential side effects. The weakness of any chemical weapon is that adequate protection must be provided to the operator, lest they too fall victim to its effects.

A type of non-lethal chemical weapon currently in development is a kind of sleeping gas. A chemical spray that makes people fall asleep before noticing what's happening would be ideal in a terrorist-hostage situation.

An area of research that may be of great value to operations done at night is the blindingly bright xenon flashlight. Coupled with a computer chip that controls the micro-second timing of the flash with goggles that become opaque to protect the operator, this weapon could prove to be very effective. Unfortunately, along with stunning the threat, the flash may cause the eyeball to explode or permanently blind the individual. Because of this, the U.S. recently banned use of this type of device. Research is still ongoing though, and it is possible that a safer version of this weapon will emerge soon. Peripheral areas of research from this technology include flashes or lasers that will destroy aiming, optic, and sighting equipment of the enemy.

Weapons that immobilize include nets, sticky foam, and super lubricants. The net is a very basic type of non-lethal weapon that usually includes a harmless smoke screen to disorientate the threat to enable the operators to get close enough to capture him. The obvious downfall of such a device is the operator must come in close range with the threat. To work properly, the use of nets must be conducted by more than one individual, usually three or four. Because of this, the net is not an extremely effective weapon in military operations.

A weapon that is not only feasible but which has already been carried into a conflict is sticky foam. Carried on the backs of some marines when they entered Somalia, sticky foam is dispensed from a high powered, self-contained backpack not unlike a flame-thrower. the operator shoots the foam at the legs of the threat and immobilizes it. The inevitable weakness if that the threatening individual still has the use of his hands, in which he may be carrying a weapon. The natural response to this, enveloping the entire body in foam, is not recommended because if inhaled it would kill the individual by suffocation. To circumvent this, it is possible to add more punch to the foam by lacing it with irritants such as pepper spray. This would combine the goal of immobilizing as well as deterring others and still causing significant irritation to the restrained individual so that he would be less likely to counterattack. One downside to this weapon is the apprehension of the individual. The foam is difficult to remove and requires solvents to get it off completely. If the foam was pulled off the body quickly, it would remove skin. This weapon, while proven to be effective by law enforcement agencies, could pose a problem in areas of the world where solvents are not available.

A type of foam that immobilizes without being sticky is super foam. Dispensed from a portable generator type device with a 275 gallon tank, the foam covers an area about 200 feet long by 20 feet wide and 4 feet high. the foam is often laced with irritants and its primary purpose is to serve as a barrier. While it looks like soap suds, the consistency is denser and does not blow away in the wind. Used for crowd control or to block the entrance to an embassy or other building the foam is quite effective. Although portability of the generator is a question, this foam has excellent potential in limited applications.

An interesting non-lethal weapon that might resemble something from a comedy movie is super lubricants. The lubricants could be applied in a building hallway to make it virtually impossible to pass through without falling. Similar applications could be used on roads to inhibit the progress of a vehicle. These super lubricants are Teflon based that may be very effective in creating a barrier that cannot be crossed quickly. This would give soldiers ample warning to respond to a threat with additional force.

The final type of weapons that immobilize are radio frequency weapons. These weapons come in a wide variety of choices; not all are designed for antipersonnel use, but categorizing them in this classification seems appropriate. The simplest type of radio frequency weapon is commonly used by the PSYOPs community: loudspeakers. These speakers, mounted on a truck, broadcast messages in an attempt to persuade or demoralize the potentially threatening population.

A more potent RF weapon currently under development is the high powered very low frequency(VLF) modulator. Working in the 20-35 KHz spectrum, the frequency emits from a 1-2 meter antenna dish to form into a type of acoustic bullet. The weapon is especially convenient because the power level is easily adjustable. At its low setting, the acoustic bullet causes physical discomfort—enough to deter most approaching threats. Incrementally increasing the power nets an effect of nausea, vomiting and abdominal pains. The highest settings can cause a person's bones to resonate, which is very painful, as it can ultimately cause the bones to literally expose internally. Aimed at the head, the resonating skull bones have caused people to hear “voices”. Researched by the Russian military more extensively than by the U.S., the Russians actually offered the use of such a weapon to the FBI in the Branch Davidian standoff to make them think that “God” was talking to them. Concerned with the unpredictability of what the voices might actually say to the followers, the FBI declined the offer. Another RF weapon that was ready for use back in 1978 was developed under the guise of Operation PIQUE. Developed by the CIA, the plan was to bounce high powered radio signals off the ionosphere to affect the mental functions of people in selected areas, including Eastern European nuclear installations.

Hostage rescue is a situation that also lends itself extremely well for the use of non-lethal weapons. Killing the terrorists is not necessarily a concern: killing the hostages is. To circumvent this, measures such as a high-powered direct energy weapons would instantly kill them with no lateral damages. Mentioned before, a sleeping gas would be effective to overcome the terrorists before they realized what was happening to safely extract the hostages. Another weapon that would be of some use is CS gas. Designed to create a diversion long enough to get in better positions to kill the terrorists, the CS gas does not have any lasting effect on the hostages.

Realizing that the United States has involved itself in a great many situations that fall into MOOTW, the development and creation of the weapons examined is of vital military necessity.

It is a primary object of the present invention to provide a non-lethal weapon system for aircraft that ameliorates many of the problems noted above.

### SUMMARY OF THE PRESENT INVENTION

In accordance with the present invention, an aircraft integrated non-lethal weapon system AINLWS is provided for commercial aircraft with a sealed bulkhead between the cockpit in the cabin. The cockpit has an air-conditioning system CAS separate from the cabin air-conditioning system PAS. A non-lethal weapon material is injected into the cabin by an NLW supply system, and the cabin is exhausted after hijacker securement, by an NLW exhaust system and returned to the normal cabin air system.

Non-lethal weapon NLW systems provide the best opportunity to minimize on-board hijacking because if designed properly, can disable the hijacker with reversible effects on the passengers, and after hijacker capture and securement, quickly return the cabin environment to normal, NLW free, minimizing any residual effects on the passengers.

The cabin passenger environment because completely enveloped, provides an ideal environment for the use of certain NLW materials because the cabin envelope confines those materials to the cabin as opposed to an outdoor or large building environment where the NLW materials would be directed to non-effective areas, thus requiring far greater quantities of the NLW materials. Furthermore, the quantification of the interior cabin volume by the NLW system designer, according to the present invention, would be a relatively easy calculation. Furthermore, this fixed volume environment for the NLW materials enables the quick and rapid exhaustion of the NLW materials after securement of the hijackers to minimize disabling effects on the passengers. Of course, the materials selected as NLW materials for the present system must create a balance between minimizing passenger injury while providing sufficient effect to immobilize hijackers sufficiently to permit rapid and safe capture.

As discussed above, NLW systems include stun guns, chemical weapons, CS tear gas, sleeping gas, sticky foam, nets, super lubricants, super foam, radio frequency weapons, laser focusers, ultrasound emiters, microwave pulse generators, and many others.

The present invention defines non-lethal material NLWM as any substance presently, or in the future, used in NLW technology that when used in an aircraft having an unsealed bulkhead separating the cockpit from the cabin may when initiated in the cabin, penetrate the bulkhead and enter the cockpit. This definition would include gases, chemicals, sprays, foams, without any specific limitation to this list. It would exclude flame injectors, solid projectiles, and structural damaging explosives, as well as obviously any substance or object that would be lethal to the major portion of the passenger population in the aircraft.

The present AINLWS includes a separate cockpit air system CAS that operates in the S-mode to maintain cockpit environment during cabin assault.

When activated by an interior master control, the NLW material supply injects NLW material into the cabin disabling both passengers and terrorists-hijackers. After the hijackers have been disabled sufficiently, which could be viewed by a video camera from the cockpit area for example, the cabin is entered by cockpit marshals or other cockpit personnel and the terrorists-hijackers bound or otherwise confined. Thereafter, the master control is activated to initiate the NLW material exhaust system to exhaust the cabin of NLW material and return the cabin environment under the control of the normal cabin air system PAS.

It should be understood that the NLW material supply system, according to the present invention, could be integrated into the cabin air system including supply nozzles and return vents or could be a completely separate system. The separate system, of course, has the advantage of not contaminating the main cabin air system. However, because of the thousands of aircraft that need to be retrofitted with the present NLW system, it would be more expeditious to integrate the NLW system into the cabin air system.

Other objects and advantages of the present system will appear more clearly from the following detailed description.

### BRIEF DESCRIPTION OF THE DRAWINGS

FIG. 1 is a side view of a Boeing 7671 with the present AINLWS installed; 1. Boeing 767 is a trademark of Boeing, Inc.

FIG. 2 is a top view of the aircraft illustrated in FIG. 1, and;

FIG. 3 is a cross section taken along line 3-3 of FIG. 2 showing the cockpit bulkhead from the passenger cabin.

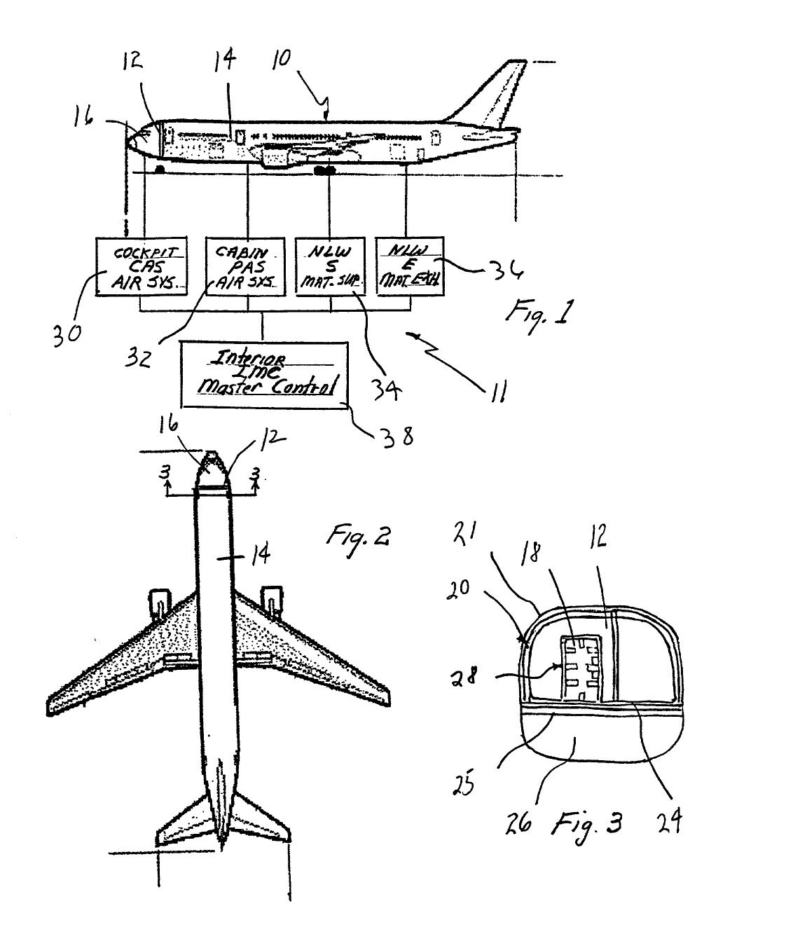

### DETAILED DESCRIPTION OF THE PREFERRED EMBODIMENT

Referring to the drawings, a Boeing 767 10 is illustrated according to the present invention that is retrofitted with the present aircraft integrated non-lethal weapon system AINLWS 11. It should be understood that the present invention can either be retrofitted into existing aircraft or it may be incorporated as an OEM feature in new aircraft. In retrofitting aircraft, it may be desirable to utilize portions of existing air-conditioning system condensers, evaporators, heaters, nozzles, exhaust ducting and vents with the present NLW system, or in the case of new aircraft, it may be desirable to provide separate NLW material supply nozzles and separate NLW material exhaust venting. In any event, the present invention encompasses either of these alternatives.

Firstly, the present invention contemplates a restructured bulkhead 12 between cabin 14 and cockpit 16. Such securement would include a double titanium wall with insulation material that would inhibit both the mechanical invasion by terrorists into the cockpit but also inhibit the opening of the bulkhead by small explosive devices ignited on the passenger side of the bulkhead 12. It should be understood that the details of reinforcing both bulkhead 12 and cockpit entry door 18 illustrated in FIG. 3, form no specific part of the present invention other than the benefits of such structural securement, but should preferably be utilized in conjunction with the present invention.

Viewing FIG. 3 and in accordance with the present invention, a heavy elastomeric seal 20 is provided around bulkhead 12 between the bulkhead and the aluminum skin 21 of the fuselage area surrounding the bulkhead 12 and it includes a horizontal portion 24 along the flooring 25 separating the cockpit from the lower area 26. Furthermore, security cockpit door 18 is also surrounded by an elastomer 28. The purpose of the elastomers 20 and 28 is to seal the cockpit 16 from the NLW materials in the cabin 14 when activated.

Suitable materials for the elastomers 20 and 28 are a variety of polyurethane materials manufactured by Dow Corning in the durometer range of Shore A 40 to 70.

An important aspect of the present invention is that the cockpit is provided with a cockpit air system 30 CAS that is completely separate from a cabin air system 32 PAS. In this way there is no cross-contamination between cockpit air and cabin air and/or NLW materials in the cabin.

When a hijacking situation is encountered, the NLW material supply 34S is activated in the cabin compartment with a controlled amount of NLW material as defined above disabling both the passengers and terrorists. Federal marshals or cockpit personnel then emerge from cockpit 16, secure the terrorists-hijackers, and a non-lethal weapon material exhaust system 36E is activated, exhausting the cabin of NLW material and returning the cabin to its normal cabin air system 36.

These functions may be controlled by an interior master control IMC, along with the appropriate software and incident programs, which carefully control the amount of NLW material supplied. The rapid and timely initiation of the material exhaust system 36 minimizes the after-effects and possible permanent disabling effects of the NLW material to passengers.

1. An integrated NLW system for aircraft, having a cockpit separated from a cabin by a cockpit bulkhead, comprising: a seal system for the bulkhead impervious to the selected NLW material in the cabin, and an NLW supply system for the cabin.

2. An integrated NLW system for aircraft as defined in claim 1, including a first air conditioning system for the cockpit, and a second air conditioning system for the cabin.

3. An integrated NLW system for aircraft as defined in claim 1, and an exhaust system E for cabin NLW material.

4. An integrated NLW system for aircraft as defined in claim 3, and an interior master control IMC for activating the NLW supply system and for thereafter terminating the S and activating the exhaust system E.

5. An integrated NLW system for aircraft having a cockpit separated from the cabin by a bulkhead, comprising: a first air-conditioning system for the cockpit, a second air-conditioning system for the cabin that does not exhaust cabin gas or material into the cockpit, an NLW material supply system for the cabin, and a seal system for the cockpit bulkhead to prevent the entry of significant amounts of NLW material into the cockpit from the cabin.

6. An integrated NLW system for aircraft as defined in claim 5, an exhaust system for exhausting NLW material from the cabin without entry to the cockpit, and a control IMC for initiating the NLW supply system and for thereafter terminating the NLW supply system and initiating the exhaust system.
